(19) United States
(12) Patent Application Publication
(10) Pub. No.: US 2020/0102860 A1
(43) Pub. Date: Apr. 2, 2020

(54) CAM FOLLOWER DEVICE

(71) Applicant: JTEKT CORPORATION, Osaka-shi, Osaka (JP)

(72) Inventors: Kunihiro YAMAGUCHI, Nagoya-shi (JP); Masaki TOYAMA, Oume-shi (JP)

(73) Assignee: JTEKT CORPORATION, Osaka-shi, Osaka (JP)

(21) Appl. No.: 16/620,594

(22) PCT Filed: Jul. 10, 2018
(86) PCT No.: PCT/JP2018/026013

§ 371 Date: Dec. 9, 2019

(30) Foreign Application Priority Data
Jul. 10, 2017 (JP) 2017-134561

(51) Int. Cl. F01L 1/18; F16H 53/06; F16H 53/02

(52) U.S. Cl. CPC F01L 1/182; F01L 2001/0476; F16H 53/025; F16H 53/06

(57) ABSTRACT

A cam follower device includes: a bearing holding member that has a pair of opposing side walls disposed with a space therebetween and that is arranged with respect to a cam provided on a camshaft; a support shaft inserted into insertion holes provided coaxially in each of the pair of opposing side walls; an outer ring that has the support shaft inserted therethrough, is disposed between the pair of opposing side walls, and faces the cam; an inner ring formed by an outer peripheral surface of the support shaft; and a plurality of rollers disposed in an annular gap between the outer ring and the inner ring.

### TECHNICAL FIELD

One aspect of the present invention relates to a cam follower device.

### BACKGROUND ART

For example, Patent Literature 1 describes a cam follower device 150 of related art shown in FIGS. 11 to 13. As shown in FIG. 11, the cam follower device 150 of the related art disclosed in Patent Literature 1 includes a rocker arm 130, an outer ring 120, a support shaft 122, and a plurality of rollers 124. As shown in FIG. 12, which is a cross-sectional view taken along line XII-XII in FIG. 11, the rocker arm 130 includes a pair of opposite side walls 138, and an insertion hole 132 into which the support shaft 122 is inserted is provided coaxially in each of the opposite side walls 138. The outer ring 120 is disposed between the pair of opposite side walls 138, and the support shaft 122 is inserted into the insertion hole 132 of each of the pair of opposite side walls 138 and the outer ring 120. In space between an outer peripheral surface 121 of the support shaft 122 and an inner peripheral surface of the outer ring 120, the plurality of rollers 124 are rotatably disposed around an entire periphery, and the outer ring 120 is rotatable with respect to the support shaft 122. Two end portions of the support shaft 122 are fixed to the opposite side walls 138 by caulking portions K in the insertion holes 132 of the opposite side walls 138 so that the support shaft 122 does not slip off from the rocker arm 130, and the support shaft 122 is not rotatable about an axis with respect to the opposite side walls 138.

Patent Literature 2 describes a cam follower device in which an inner ring is provided between the support shaft and the rollers as compared with the cam follower device described in Patent Literature 1. The inner ring is fixed to the support shaft so as to be integral with the support shaft, and the support shaft is attached to the rocker arm so as to be rotatable with respect to the rocker arm (opposite side walls).

### CITATION LIST

### Patent Literature

### [Patent Literature 1] JP-A-2014-169627

### [Patent Literature 2] JP-A-2013-167236

### SUMMARY OF INVENTION

### Technical Problems

As shown in FIG. 11, in the cam follower device 150 described in Patent Literature 1, a cam 110 rotates while being in contact with the outer ring 120. Therefore, the outer ring 120 rotates in accordance with the rotation of the cam 110 in contact therewith. When an eccentric portion 110C of the cam 110 contacts the outer ring 120, the cam 110 presses down the cam follower device 150 without rotating the outer ring 120. This state is shown in an enlarged view of FIG. 13. At this time, as shown in FIG. 13, a press-down force F is transmitted from the cam 110 to the support shaft 122 via the outer ring 120 and the rollers 124. At this time, since the outer ring 120 rotates in accordance with the rotation of the cam 110, regions of the outer ring 120 that receive the press-down force F are at various positions in a peripheral direction and are not concentrated at one place. Since the plurality of rollers 124 revolve about the support shaft 122 while rotating in accordance with the rotation of the outer ring 120, the press-down force F is not concentrated on one specific roller 124. However, since the support shaft 122 is fixed in the insertion hole 132 of the rocker arm 130 and does not rotate, the press-down force F is concentrated in a region Z (load circle) shown in FIG. 13. That is, in the peripheral direction of the support shaft 122, only the region Z located at a specific position receives the press-down force F (repeated load) each time. For this reason, fatigue peeling may occur in the region Z of the support shaft 122, and a service life of the cam follower device may be shortened.

In Patent Literature 2, since the support shaft integrated with the inner ring is rotatable with respect to the rocker arm, the inner ring and the support shaft also rotate in accordance with the rotation of the outer ring or the rollers. Therefore, the press-down force from the cam is not concentrated at one portion of the support shaft in the peripheral direction. Therefore, it is considered that a service life thereof can be longer than that of the cam follower device described in Cited Document 1. However, the number of components is increased as compared with Patent Literature 1 (addition of the inner ring), which is not preferable since a structure thereof becomes complicated.

An aspect of the present invention has been made in view of the above circumstances, and an object thereof is to provide a cam follower device which has a simple structure and can prevent occurrence of rolling fatigue peeling on a support shaft, so as to improve service life thereof.

### Solution to Problem

So as to solve the above problems, in a first aspect, a cam follower device includes a bearing holding member including a pair of opposite side walls provided in a state that is spaced apart from each other and disposed with respect to a cam provided on a camshaft, a support shaft inserted into each of insertion holes which are coaxially provided in the pair of opposite side walls, an outer ring disposed between the pair of opposite side walls in a state that the support shaft is inserted, and facing the cam, an inner ring formed on an outer peripheral surface of the support shaft, and a plurality of rollers disposed in an annular gap between the outer ring and the inner ring. The cam follower device configured to swing corresponding to movement of the cam. Slip-off preventing structures preventing the support shaft from slipping off from the bearing holding member are provided on one end side and the other end side of the support shaft. The support shaft is rotatable about an axis of the support shaft with respect to the bearing holding member.

In a second aspect, the slip-off preventing structure on the one end side of the support shaft includes a collar portion having an outer diameter larger than a diameter of the insertion hole and sandwiching one of the pair of opposite side walls, the collar portion being provided on a side opposite to the outer ring.

In a third aspect, the slip-off preventing structure on the one end side of the support shaft includes a groove portion provided on an outer peripheral surface of the one end side of the support shaft so as to be continuous in a peripheral direction, and the insertion hole set to have a diameter larger than an outer diameter of the groove portion and smaller than an outer diameter of the support shaft and corresponding to the groove portion.

In a fourth aspect, the slip-off preventing structures on the one end side and the other end side of the support shaft includes an open portion being opened in a portion in a cam side of each of the insertion holes in the pair of opposite side walls and having a width smaller than the diameter of the insertion hole, and a groove portion provided on each of the outer peripheral surfaces of the one end side and the other end side of the support shaft so as to be continuous in the peripheral direction and so as to have an outer diameter larger than the width of the open portion and smaller than the diameter of the insertion hole.

In a fifth aspect, the slip-off preventing structure on the other end side of the support shaft is a structure including a caulking portion having an outer diameter larger than the diameter of the insertion hole through which the support shaft is inserted, a structure in which a fixing groove portion is provided on an outer peripheral surface of the other end side of the support shaft so as to be continuous in the peripheral direction and a C-ring or an O-ring is fitted into the fixing groove portion, or a structure in which a male screw portion is provided on the other end of the support shaft and a fastening member including a female screw portion corresponding to the male screw portion is screwed together.

### Advantageous Effects of Invention

According to the first to fourth aspects, the support shaft can rotate about the axis of the support shaft with respect to the bearing holding member. Therefore, a load circle on the outer peripheral surface of the support shaft is not limited to a certain range (the same region) with respect to the rotation of the cam, and is not limited to one place. Accordingly, rolling fatigue peeling caused by repeated roller load can be prevented from occurring in one place (load circle) of the support shaft, and a service life of the cam follower device can be improved. Since the support shaft is used as the inner ring, a structure thereof can be simpler.

According to the fifth aspect, in the cam follower device according to the second aspect or the third aspect, the slip-off preventing structure on the other end side of the support shaft can be realized relatively easily with a simpler structure.

### BRIEF DESCRIPTION OF DRAWINGS

FIG. 1 is a perspective view showing an overall configuration of a cam follower device.

FIG. 2 shows an operation of the cam follower device.

FIG. 3 is a cross-sectional view taken along line of FIG. 2, and shows a structure of a cam follower device according to a first embodiment.

FIG. 4 shows rotation of a cam and rotation of a support shaft in a cam follower device according to the present application.

FIG. 5 is a cross-sectional view showing a structure of a cam follower device according to a second embodiment, and corresponds to FIG. 3.

FIG. 6 is a cross-sectional view showing a structure of a cam follower device according to a third embodiment, and corresponds to FIG. 3.

FIG. 7 is a cross-sectional view showing a structure of a cam follower device according to a fourth embodiment, and corresponds to FIG. 3.

FIG. 8 is a cross-sectional view showing a structure of a cam follower device according to a fifth embodiment, and corresponds to FIG. 3.

FIG. 9 is an exploded perspective view showing an overall configuration of a cam follower device according to a sixth embodiment.

FIG. 10 is a cross-sectional view showing a structure of a cam follower device according to the sixth embodiment, and corresponds to FIG. 3.

FIG. 11 shows an example of a cam follower device in related art.

FIG. 12 is a cross-sectional view taken along line XII-XII of FIG. 11, and shows a structure of the cam follower device of the related art.

FIG. 13 shows that a pressing force from a cam is concentrated at one place of a support shaft in the cam follower device of the related art.

### DESCRIPTION OF EMBODIMENTS

Embodiments of the present invention (first to sixth embodiments) will be described below with reference to the drawings. Each cam follower device shown in the first to sixth embodiments includes slip-off preventing structures which prevent a support shaft from slipping off from a rocker arm (corresponding to a bearing holding member) on one end side and the other end side of the support shaft. The support shaft is rotatable about an axis of the support shaft with respect to the rocker arm (corresponding to the bearing holding member).

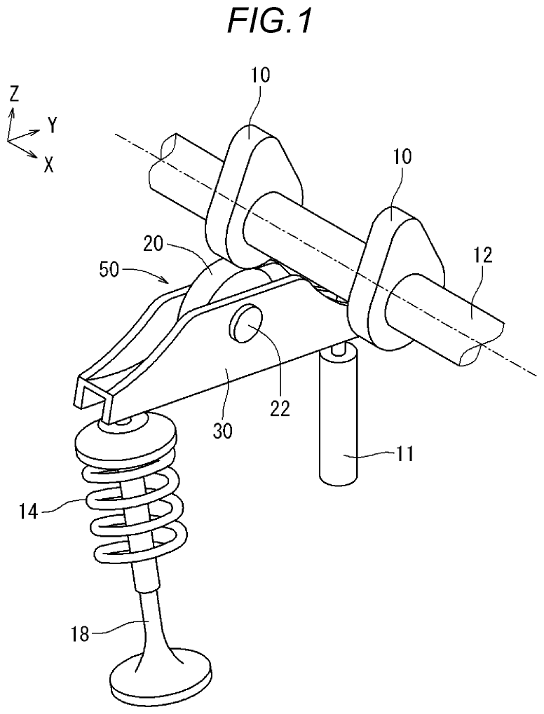

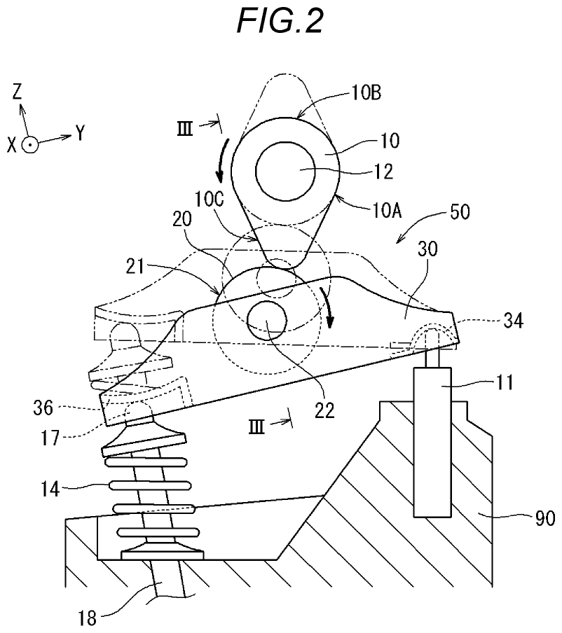

### [Overall Configuration of Cam Follower Device 50 (FIGS. 1 and 2)]

First, an outline of a configuration and an operation of the cam follower device will be described with reference to FIGS. 1 and 2. As shown in FIG. 1, a cam follower device 50 includes a rocker arm 30, an outer ring 20, and a support shaft 22. As shown in FIG. 2, a valve mechanism (a valve stem end 17, a spring 14, and a valve 18) and a lash adjuster 11 are provided on two longitudinal direction end portions of the rocker arm 30 so as to support the end portions. The valve 18 is provided in a cylinder head 90 in an openable and closable manner, and the lash adjuster 11 is fixed to the cylinder head 90. In figures where X axis, Y axis, and Z axis are shown, the X axis, Y axis, and Z axis are orthogonal to each other. A Y-axis direction refers to a longitudinal direction of the rocker arm 30. In FIG. 2, a direction from the valve stem end 17 toward the lash adjuster 11 is the Y-direction, and an X-axis direction refers to a direction parallel to a central axis of the cam 10.

As shown in FIG. 2, the rocker arm 30 is provided with a recessed lash adjuster receiving portion 34 configured to receive a tip end of the lash adjuster 11, and a valve stem end receiving portion 36 which receives the valve stem end 17 on two longitudinal direction ends of the rocker arm 30 respectively.

In FIG. 2, the lash adjuster 11 abuts against the lash adjuster receiving portion 34, while the valve stem end 17 abuts against the valve stem end receiving portion 36. An outer peripheral surface of the cam 10 abuts against an outer peripheral surface of the outer ring 20. Accordingly, the cam follower device 50 is supported relative to the cylinder head 90 at the three places described above. An outer peripheral surface 21 of the outer ring 20 and an outer peripheral surface 10A of the cam 10 face each other in the cam follower device 50.

As shown in FIG. 2, when an eccentric portion 10C abuts against the outer ring 20 due to rotation of a camshaft 12, the cam 10 presses the abutted outer ring 20 down toward a certain side of the cylinder head 90. Accordingly, the cam follower device 50 rotates (swings) about the lash adjuster receiving portion 34 serving as a center (fulcrum) and presses down the valve stem end 17 toward the cylinder head 90 to open the valve 18. When the camshaft 12 rotates, a base circumferential portion 10B of the cam 10 abuts against the outer ring 20, the valve stem end 17 swings due to an urging force of the spring 14 so as to be pressed back to an original position (a position where the valve 18 is closed), and the valve 18 is closed.

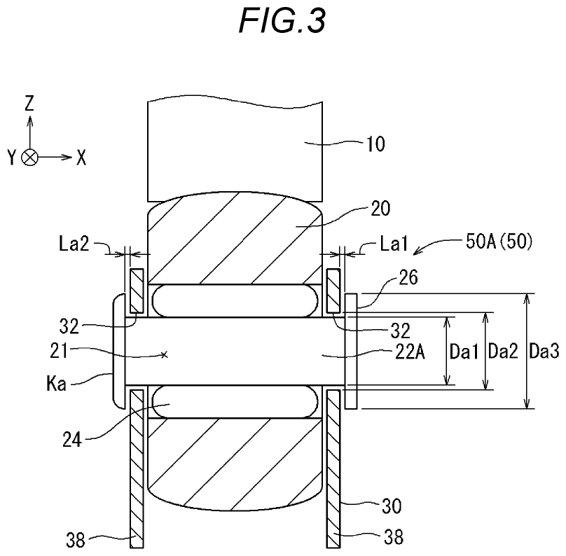

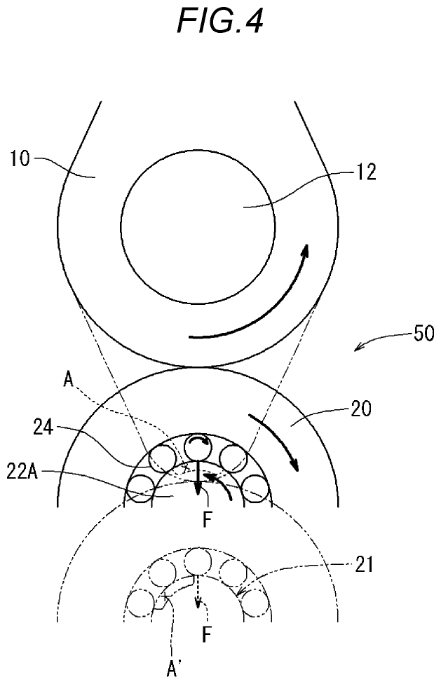

### Structure and Effect of Cam Follower Device 50A According to First Embodiment (FIGS. 3 and 4)

Next, a cam follower device 50A according to a first embodiment will be described with reference to FIGS. 3 and 4. FIG. 3 shows a cross section of the cam follower device 50A according to the first embodiment. The cam follower device 50A includes the rocker arm 30, a support shaft 22A, the outer ring 20, and rollers 24. FIG. 4 is an enlarged view showing a state before the cam 10 presses down the outer ring 20 (solid line) and a pressed state (two-dot chain line). In the first embodiment, a slip-off preventing structure on one end side of the support shaft 22A includes a collar portion 26. The slip-off preventing structure on the other end side of the support shaft 22A includes a caulking portion Ka.

As shown in FIG. 3, the rocker arm 30 includes a pair of opposite side walls 38 provided in a state of being spaced apart from each other, and is disposed with respect to the cam 10 provided on the camshaft 12 (see FIG. 2). Insertion holes 32 are provided coaxially with each of the pair of opposite side walls 38. The support shaft 22A is inserted into each of the insertion holes 32 of the pair of opposite side walls 38. The outer ring 20 is disposed between the pair of opposite side walls 38 through which the support shaft 22A is inserted, and faces the cam 10. A plurality of rollers 24 are disposed in an annular gap between an inner ring formed by an outer peripheral surface 21 of the support shaft 22A and the outer ring 20.

The collar portion 26 has a diameter Da3 larger than a diameter Da2 of the insertion hole 32, and is provided on the one end side of the support shaft 22A (sandwiching the opposite side walls 38 and being provided on a side opposite to the outer ring 20). The support shaft 22A is formed with the caulking portion Ka on the other end side of the support shaft 22A, so as to prevent the support shaft 22A from slipping off from the rocker arm 30. A gap La1 is provided between a wall surface of the opposite side wall 38 on a side not facing the outer ring 20 and a surface of an outer edge portion of the collar portion 26 facing this wall surface. A gap La2 is provided between a wall surface of the opposite side wall 38 on a side where the outer ring 20 is not disposed and a surface of an outer edge portion of the caulking portion Ka facing this wall surface. The diameter Da2 of the insertion hole 32 is larger than a diameter Da1 of the support shaft 22A. Accordingly, the support shaft 22A is rotatable about an axis of the support shaft 22A with respect to the rocker arm 30.

As shown in FIG. 4, for example, when the camshaft 12 rotates and the cam 10 rotates from a position indicated by the solid line to a position indicated by the two-dot chain line, the outer ring 20 is rotated and pressed down toward the cylinder head 90 by the cam 10. Accordingly, as shown in FIG. 2, the rocker arm 30 rotates (swings) about the lash adjuster receiving portion 34 toward the cylinder head 90 to open the valve 18. The rollers 24 rotate in accordance with rotation of the outer ring 20. As described above, the support shaft 22A is rotatable with respect to the rocker arm 30.

As shown in FIG. 4, since the support shaft 22A rotates with respect to the rocker arm 30 (see FIG. 2), a region A (load circle) of the support shaft 22A, which receives a force pressing down the outer ring 20 from the cam 10, rotates about the axis of the support shaft 22A and moves (region A′). Therefore, the load circle on the outer peripheral surface 21 of the support shaft 22A is not limited to a certain range with respect to the rotation of the cam 10, and is not one place. Accordingly, the same region on the outer peripheral surface 21 of the support shaft 22A does not always receive the load from the cam 10. That is, various regions in the peripheral direction of the support shaft 22A receive the load. Therefore, since the problem that a specific portion (the same portion) of the support shaft 22A repeatedly receives the load to cause fatigue peeling can be prevented, a service life of the cam follower device can be further improved.

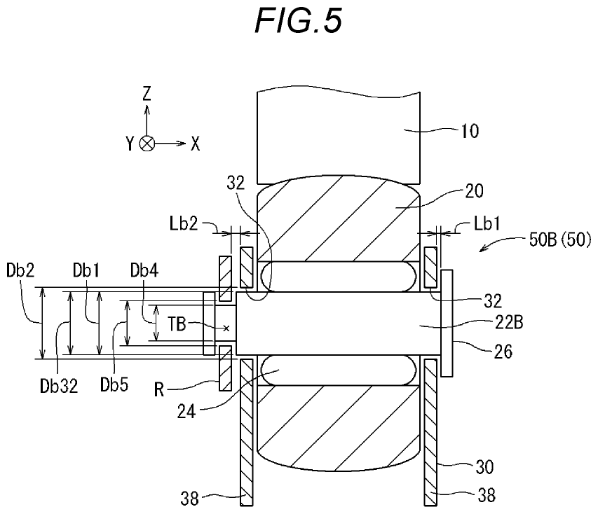

### Structure and Effect of Cam Follower Device 50B According to Second Embodiment (FIG. 5)

Next, a cam follower device 50B according to a second embodiment will be described with reference to FIG. 5. In the cam follower device 50B, the slip-off preventing structure on the other side of a support shaft 22B prevented from slipping off the rocker arm 30 prevents the support shaft 22B from slip-off by fitting a C-ring or O-ring into a groove provided in the support shaft 22B, which is different from the cam follower device 50A according to the first embodiment. Hereinafter, this difference will be mainly described.

In the cam follower device 50B according to the second embodiment, as shown in the cross-sectional view of FIG. 5, the slip-off preventing structure provided on the one end side of the support shaft 22B is the same collar portion 26 as that of the first embodiment, thus a description of the collar portion 26 will be omitted. The slip-off preventing structure on the other end side of the support shaft 22B has a structure in which a fixing groove portion TB is provided on an outer peripheral surface on the other end side of the support shaft 22B so as to be continuous in the peripheral direction while a ring R (C-ring or O-ring) is fitted into the fixing groove portion TB.

A diameter Db4 of the fixing groove portion TB of the support shaft 22B is smaller than a hole diameter Db5 of the ring R. A diameter Db1 of the support shaft 22B is larger than the diameter Db5 and smaller than a diameter Db2 of the insertion hole 32. A diameter Db32 of the other end of the support shaft 22B is smaller than an inner diameter of the insertion hole 32 of the opposite side wall 38. An outer diameter of the ring R is larger than the diameter Db2 of the insertion hole 32.

A gap Lb1 is provided between the wall surface of the opposite side wall 38 on the side not facing the outer ring 20 and the surface of the outer edge portion of the collar portion 26 facing this wall surface. A gap Lb2 is provided between the wall surface of the opposite side wall 38 on the side not facing the outer ring 20 and a surface of an outer edge portion of the ring R facing this wall surface. Accordingly, the support shaft 22B is rotatable about an axis of the support shaft 22B with respect to the rocker arm 30. Therefore, similarly to the first embodiment, since the problem that a specific portion (the same portion) of the support shaft 22B repeatedly receives the load to cause fatigue peeling can be prevented, the service life of the cam follower device can be further improved.

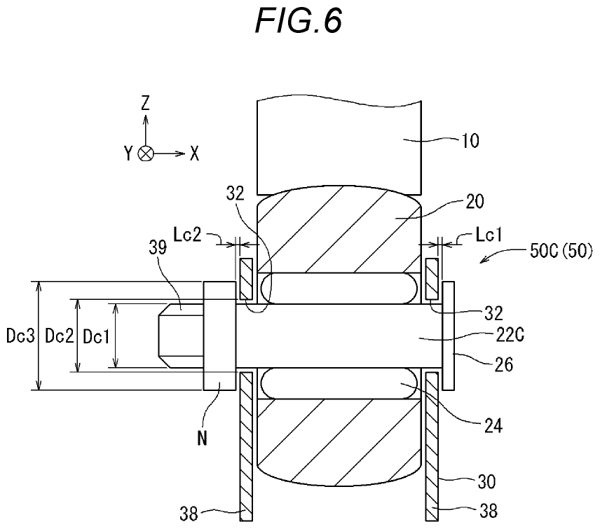

### Structure and Effect of Cam Follower Device 50C According to Third Embodiment (FIG. 6)

Next, a cam follower device 50C according to a third embodiment will be described with reference to FIG. 6. In the cam follower device 50C, the slip-off preventing structure on the other side of a support shaft 22C prevented from slipping off the rocker arm 30 prevents the support shaft 22B from slip-off by fastening a fastening member (for example, a nut) to the support shaft 22C, which is different from the cam follower device 50A according to the first embodiment. Hereinafter, this difference will be mainly described.

In the cam follower device 50C according to the third embodiment, as shown in the cross-sectional view of FIG. 6, the slip-off preventing structure provided on the one end side of the support shaft 22C is the same collar portion 26 as that of the first embodiment, thus the description of the collar portion 26 will be omitted. The slip-off preventing structure on the other end side of the support shaft 22C has a structure in which a male screw portion 39 is provided on the other end of the support shaft 22C while a fastening member N (for example, a nut) including a female screw portion corresponding to the male screw portion 39 is screwed together.

A dimension Dc3 of an outer shape of the fastening member N is larger than a diameter Dc2 of the insertion hole 32 to such a degree that the support shaft 22C does not slip out of the insertion hole 32. A diameter Dc1 of the support shaft 22C is smaller than the diameter Dc2 of the insertion hole 32.

A gap Lc1 is provided between the wall surface of the opposite side wall 38 on the side not facing the outer ring 20 and the surface of the outer edge portion of the collar portion 26 facing this wall surface. A gap Lc2 is provided between the wall surface of the opposite side wall 38 on the side not facing the outer ring 20 and a surface of an outer edge portion of the fastening member N facing this wall surface. Accordingly, the support shaft 22C is rotatable about an axis of the support shaft 22C with respect to the rocker arm 30. As for screwing the fastening member N to the male screw portion 39, two fastening members N (double nuts) may be used. Accordingly, the fastening member N can be prevented from slipping off from the male screw portion 39 while the gap Lc1 and the gap Lc2 are maintained. Therefore, similarly to the first embodiment, since the problem that a specific portion (the same portion) of the support shaft 22C repeatedly receives the load to cause fatigue peeling can be prevented, the service life of the cam follower device can be further improved.

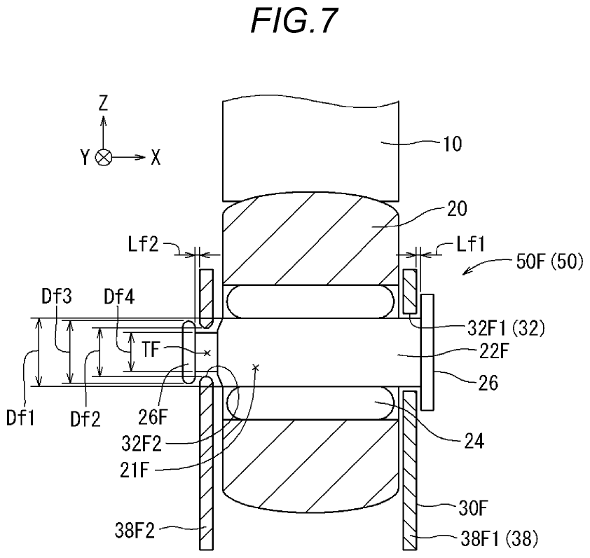

### Structure and Effect of Cam Follower Device 50F According to Fourth Embodiment (FIG. 7)

Next, a cam follower device 50F according to a fourth embodiment will be described with reference to FIG. 7. In the cam follower device 50F, the slip-off preventing structure on the other side of a support shaft 22F prevented from slipping off a rocker arm 30F includes a groove portion TF provided over an entire periphery of the support shaft 22F and an insertion hole 32F2 corresponding to the groove portion TF, which is different from the cam follower device 50A according to the first embodiment. Hereinafter, this difference will be mainly described.

In the cam follower device 50F according to the fourth embodiment, as shown in the cross-sectional view of FIG. 7, the slip-off preventing structure provided on the one end side of the support shaft 22F is the same collar portion 26 as that of the first embodiment, thus the description of the collar portion 26 will be omitted. The slip-off preventing structure on the other end side of the support shaft 22F is a structure in which a collar portion 26F provided on the support shaft 22F is snapped into an insertion hole 32F2 provided in an opposite side wall 38F2 to fit a groove portion TE to the insertion hole 32F2.

As shown in FIG. 7, the groove portion TF is provided on an outer peripheral surface 21F on the other end of the support shaft 22F so as to be continuous in the peripheral direction. A diameter Df4 of the groove portion TF is smaller than a diameter Df2 of the insertion hole 32F2. A diameter of an insertion hole 32F1 in an opposite side wall 38F1 is larger than an outer diameter Df3 of the collar portion 26F, and larger than an outer diameter Df1 of the support shaft 22F. The diameter Df3 of an outer shape of the collar portion 26F is larger than the diameter Df2 of the insertion hole 32F2 to such a degree that the support shaft 22F does not slip out of the insertion hole 32F2.

As shown in FIG. 7, in order to correspond to the groove portion TF, a side surface of the collar portion 26F may be formed as a curved surface that is protruding in a radial direction over an entire periphery. An inner side wall of the rocker arm 30F in which the insertion hole 32F2 is provided may also be formed as the curved surface that is protruding in the radial direction over the entire periphery. The rocker arm 30F is made of a metal softer than the support shaft 22F. Accordingly, the collar portion 26F is easily inserted into the insertion hole 32F2 of the opposite side wall 38F2 and snapped in.

A gap Lf1 is provided between a wall surface of the opposite side wall 38F1 on the side not facing the outer ring 20 and the surface of the outer edge portion of the collar portion 26 facing this wall surface. A gap Lf2 is provided between the wall surface of the opposite side wall 38F2 on the side not facing the outer ring 20 and a surface of an outer edge portion of the collar portion 26F facing this wall surface. Accordingly, the support shaft 22F is rotatable about an axis of the support shaft 22F with respect to the rocker arm 30F. Therefore, similarly to the first embodiment, since the problem that a specific portion (the same portion) of the support shaft 22F repeatedly receives the load to cause fatigue peeling can be prevented, the service life of the cam follower device can be further improved.

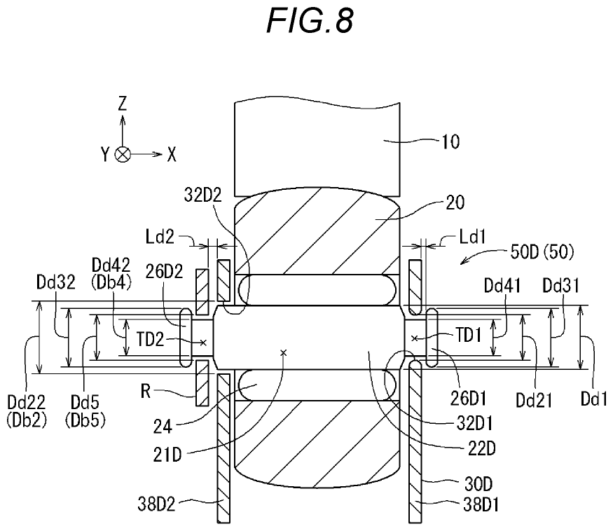

### Structure and Effect of Cam Follower Device 50D According to Fifth Embodiment (FIG. 8)

Next, a cam follower device 50D according to a fifth embodiment will be described with reference to FIG. 8. In the cam follower device 50D, the slip-off preventing structure on the one side of a support shaft 22D is not the collar portion 26, and includes a groove portion TD1 provided over an entire periphery of the support shaft 22D and an insertion hole 32D1 corresponding to the groove portion TD1, which is different from the cam follower device 50B according to the second embodiment. Hereinafter, this difference will be mainly described. The slip-off preventing structure on the other end side of the support shaft 22D is the same as that of the second embodiment, and a description thereof will be omitted. The one end side of the support shaft 22D has a structure in which a collar portion 26D1 provided on the support shaft 22D is snapped into the insertion hole 32D1 provided in an opposite side wall 38D1 to fit the groove portion TD1 to the insertion hole 32D1.

In the cam follower device 50D according to the fifth embodiment, as shown in the cross-sectional view of FIG. 8, the groove portion TD1 is provided on an outer peripheral surface 21D on the one end of the support shaft 22D so as to be continuous in the peripheral direction. A diameter Dd41 of the groove portion TD1 is smaller than a diameter Dd21 of the insertion hole 32D1.

A diameter Db22 of an insertion hole 32D2 in an opposite side wall 38D2 is larger than an outer diameter Dd31 of the collar portion 26D1. The diameter Dd31 of an outer shape of the collar portion 26D1 is larger than the diameter Dd21 of the insertion hole 32D1 to such a degree that the support shaft 22D does not slip out of the insertion hole 32D1.

As shown in FIG. 8, in order to correspond to the groove portion TD1, a side surface of the collar portion 26D1 may be formed as a curved surface that is protruding in a radial direction over an entire periphery. An inner side wall of a rocker arm 30D in which the insertion hole 32D1 is provided may also be formed as the curved surface that is protruding in the radial direction over the entire periphery. The rocker arm 30D is made of a metal softer than the support shaft 22D. Accordingly, the collar portion 26D1 is easily inserted into the insertion hole 32D1 of the opposite side wall 38D1 and snapped in. Further, the support shaft 22D may have a shape that is symmetrical in an axial direction. That is, collar portions 26D1 and 26D2 may be the same, and the groove portion TD1 and a fixing groove portion TD2 may be the same.

A gap Ld1 is provided between a wall surface of the opposite side wall 38D1 on the side not facing the outer ring 20 and a surface of an outer edge portion of the collar portion 26D1 facing this wall surface. A gap Ld2 is provided between a wall surface of the opposite side wall 38D2 on the side not facing the outer ring 20 and the surface of the outer edge portion of the ring R facing this wall surface. Accordingly, the support shaft 22D is rotatable about an axis of the support shaft 22D with respect to the rocker arm 30D. Therefore, similarly to the second embodiment, since the problem that a specific portion (the same portion) of the support shaft 22D repeatedly receives the load to cause fatigue peeling can be prevented, the service life of the cam follower device can be further improved.

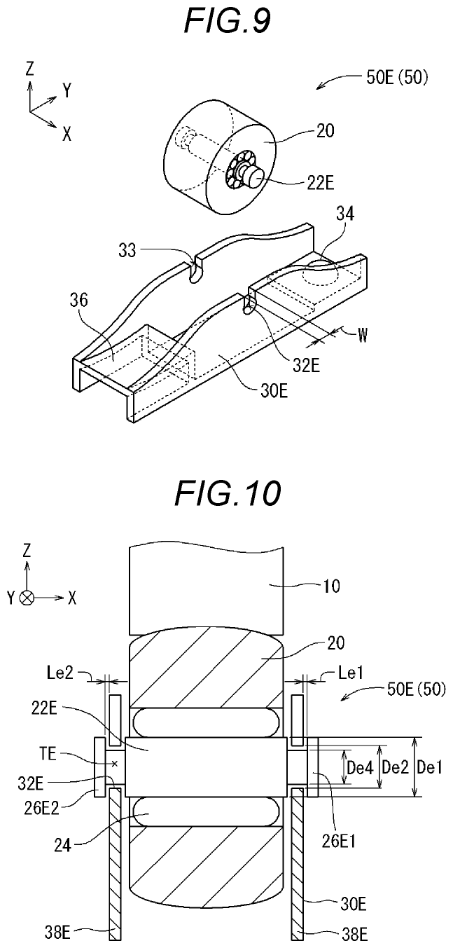

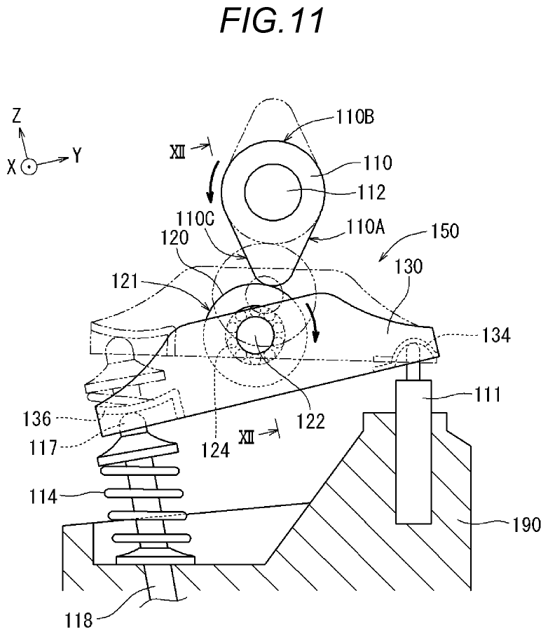

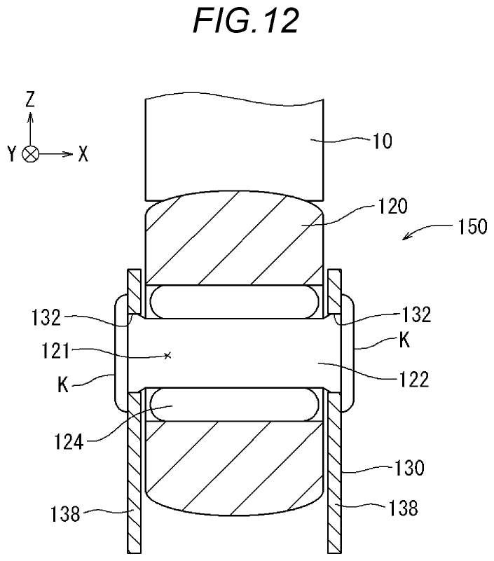

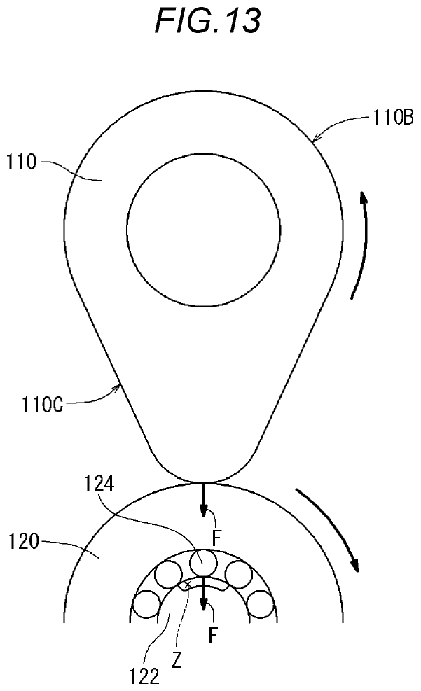

### Structure and Effect of Cam Follower Device 50E According to Sixth Embodiment (FIGS. 9 and 10)

Next, a cam follower device 50E according to a sixth embodiment will be described with reference to FIGS. 9 and 10. In the cam follower device according to the sixth embodiment, the slip-off preventing structures on the one side and the other end side of a support shaft 22E are structures shown in FIGS. 9 and 10, which is different from the first to fifth embodiments. FIG. 9 is an exploded perspective view showing an overall configuration of the cam follower device 50E according to the sixth embodiment. FIG. 10 is a cross-sectional view showing a structure of the cam follower device 50E according to the sixth embodiment. The cam follower device 50E includes an insertion hole 32E in a rocker arm 30E, and groove portions TE provided on each outer peripheral surface on two end sides of the support shaft 22E so as to be continuous in the peripheral direction, which is different from the cam follower device 50A. Hereinafter, this difference will be mainly described.

The cam follower device 50E according to the sixth embodiment, as shown in the cross-sectional view of FIG. 10, includes the groove portions TE formed on outer peripheries of two ends of the support shaft 22E so as to be continuous in the peripheral direction. A portion on the cam 10 side of the insertion hole 32E in each of a pair of opposite side walls 38E includes an open portion 33 which is opened (see FIG. 9). An outer diameter De4 of the groove portion TE is larger than a width W (see FIG. 9) of the open portion 33, to such a degree that the support shaft 22E does not slip out of the insertion hole 32E, and smaller than a diameter De2 of the insertion hole 32E. The rocker arm 30E is made of a metal softer than the support shaft 22E. Accordingly, collar portions 26E1 and 26E2 are easily inserted into the insertion holes 32E in each of the pair of opposite side walls 38E and snapped in.

A gap Le1 is provided between a wall surface of one of the pair of opposite side walls 38E facing each other on the side not facing the outer ring 20 and a surface of an outer edge portion of the collar portion 26E1 facing this wall surface. A gap Le1 is provided between a wall surface of the other opposite side wall 38E on the side not facing the outer ring 20 and a surface of an outer edge portion of the collar portion 26E2 facing this wall surface. Accordingly, the support shaft 22E is rotatable about an axis of the support shaft 22E with respect to the rocker arm 30E. Therefore, similarly to the first embodiment, since the problem that a specific portion (the same portion) of the support shaft 22E repeatedly receives the load to cause fatigue peeling can be prevented, the service life of the cam follower device can be further improved.

### EFFECT OF THE PRESENT APPLICATION

As described above, since the support shaft rotates with respect to the rocker arm (bearing holding member) in the region (load circle) of the support shaft that receives the force pressing down the outer ring from the cam, the load circle is not limited to a certain range with respect to the rotation of the cam and is not one place. Accordingly, it is not the same region that serves as the load circle on the outer peripheral surface of the support shaft and receives the load from the cam, thus the service life of the support shaft is improved against rolling fatigue. In the case of the structure using the ring or the fastening member on the one side, it is not necessary to caulk two end portions of the support shaft, so normal quenching, instead of high frequency quenching, is sufficient for the outer peripheral surface of the support shaft, thus there is an advantage in terms of production management and cost. The improvement of the service life against rolling fatigue can ease a width, whose hardness is to be managed, on the outer peripheral surface of the support shaft, which is a rolling surface of the rollers.

The cam follower device according to the present invention is not limited to the configurations and the structures described in the present embodiments, and various modifications, additions, and deletions may be made without departing from the scope of the present invention. In particular, the shape of the rocker arm (bearing holding member) constituting the cam follower device is not limited to the shapes shown in the present embodiments, and may be any shape as long as the valve is opened and closed appropriately.

This application is based on JP-A-2017-134561 filed on Jul. 10, 2017, the contents of which are incorporated herein by reference.

### REFERENCE SIGNS LIST

10 Cam
10A Outer peripheral surface
10B Base circumferential portion
10C Eccentric portion
11 Lash adjuster
12 Camshaft
14 Spring
17 Valve stem end
18 Valve
20 Outer ring
21, 21D, 21F Outer peripheral surface
22, 22A, 22B Support shaft
22C, 22D, 22E Support shaft
22F Support shaft
24 Roller
26, 26D1, 26D2 Collar portion
26E1, 26E2, 26F Collar portion
30, 30D, 30E, 30F Rocker arm (bearing holding member)
32, 32D1, 32D2 Insertion hole
32E, 32F1, 32F2 Insertion hole
33 Open portion
34 Lash adjuster receiving portion
36 Valve stem end receiving portion
38 Opposite side wall
38D1, 38D2, 38E Opposite side wall
38F1, 38F2 Opposite side wall
39 Male screw portion
50, 50A, 50B Cam follower device
50C, 50D, 50E Cam follower device
50F Cam follower device
90 Cylinder head
110 Cam
110C Eccentric portion
120 Outer ring
121 Outer peripheral surface
122 Support shaft
130 Rocker arm (bearing holding member)
132 Insertion hole
132 Insertion hole
138 Opposite side wall
150 Cam follower device
A, A′, Z Region (load circle)
Da1, Da2, Da3 Diameter
Db1, Db2, Db32, Db4, Db5 Diameter
Dc1, Dc2 Diameter
Dd1, Dd21, Dd31, Dd41 Diameter
Df1, Df2, Df3, Df4 Diameter
De2, De3, De4 Diameter
Dc3 Dimension
K, Ka Caulk portion
La1, La2 Gap
Lb1, Lb2 Gap
Lc1, Lc2 Gap
Ld1, Ld2 Gap
Le1, Le2 Gap
Lf1, Lf2 Gap
N Fastening member
R Ring
TD1, TE, TF Groove portion
TB, TD2 Fixing groove portion
W Width
F Press-down force

1. A cam follower device comprising:
a bearing holding member including a pair of opposite side walls provided in a state that is spaced apart from each other and disposed with respect to a cam provided on a camshaft;
a support shaft inserted into each of insertion holes which are coaxially provided in the pair of opposite side walls;
an outer ring disposed between the pair of opposite side walls in a state that the support shaft is inserted, and facing the cam;
an inner ring formed on an outer peripheral surface of the support shaft; and
a plurality of rollers disposed in an annular gap between the outer ring and the inner ring,
wherein the cam follower device configured to swing corresponding to movement of the cam,
wherein slip-off preventing structures preventing the support shaft from slipping off from the bearing holding member are provided on one end side and the other end side of the support shaft, and
wherein the support shaft is rotatable about an axis of the support shaft with respect to the bearing holding member.

2. The cam follower device according to claim 1,
wherein the slip-off preventing structure on the one end side of the support shaft includes a collar portion having an outer diameter larger than a diameter of the insertion hole and sandwiching one of the pair of opposite side walls, the collar portion being provided on a side opposite to the outer ring.

3. The cam follower device according to claim 1,
wherein the slip-off preventing structure on the one end side of the support shaft comprises:
a groove portion provided on an outer peripheral surface of the one end side of the support shaft so as to be continuous in a peripheral direction; and
the insertion hole set to have a diameter larger than an outer diameter of the groove portion and smaller than an outer diameter of the support shaft and corresponding to the groove portion.

4. The cam follower device according to claim 1,
wherein the slip-off preventing structures on the one end side and the other end side of the support shaft comprising;
an open portion being opened in a portion in a cam side of each of the insertion holes in the pair of opposite side walls and having a width smaller than the diameter of the insertion hole; and
a groove portion provided on each of the outer peripheral surfaces of the one end side and the other end side of the support shaft so as to be continuous in the peripheral direction and so as to have an outer diameter larger than the width of the open portion and smaller than the diameter of the insertion hole.

5. The cam follower device according to claim 2,
wherein the slip-off preventing structure on the other end side of the support shaft is a structure including a caulking portion having an outer diameter larger than the diameter of the insertion hole through which the support shaft is inserted, a structure in which a fixing groove portion is provided on an outer peripheral surface of the other end side of the support shaft so as to be continuous in the peripheral direction and a C-ring or an O-ring is fitted into the fixing groove portion, or a structure in which a male screw portion is provided on the other end of the support shaft and a fastening member including a female screw portion corresponding to the male screw portion is screwed together.

6. The cam follower device according to claim 3,
wherein the slip-off preventing structure on the other end side of the support shaft is a structure including a caulking portion having an outer diameter larger than the diameter of the insertion hole through which the support shaft is inserted, a structure in which a fixing groove portion is provided on an outer peripheral surface of the other end side of the support shaft so as to be continuous in the peripheral direction and a C-ring or an O-ring is fitted into the fixing groove portion, or a structure in which a male screw portion is provided on the other end of the support shaft and a fastening member including a female screw portion corresponding to the male screw portion is screwed together.
